(19) United States
(12) Patent Application Publication
(10) Pub. No.: US 2003/0224132 A1
(43) Pub. Date: Dec. 4, 2003

(54) Assembled structures of carbon tubes and method for making the same

(76) Inventor: Chien-Chung Han, Hsinchu (TW)

Correspondence Address: LAW OFFICE OF LIAUH & ASSOC., 4224 WAIALAE AVE, STE 5-388, HONOLULU, HI, 96816

(21) Appl. No.: 10/600,927

(22) Filed: Jun. 19, 2003

Related U.S. Application Data
(63) Continuation-in-part of application No. 09/985,338, filed on Nov. 2, 2001, now Pat. No. 6,602,567.

(51) Int. Cl. B32B 1/08

(52) U.S. Cl. 428/36.9

(57) ABSTRACT

Two- or three-dimension assembled structures of carbon tubes and method for making the same are disclosed. Natural or synthetic fibers are first coated with a thermally stable coating material to form a coating layer over the fibers. Such coated fibers are then assembled into a desired assembled matrix, following by the treatment with an agent to enhance the binding interactions among the coated fibers within the assembled matrix. Such bound and assembled matrix of coated fibers is then employed for making the desired two- or three-dimension assembled structure of hollow carbon tubes, by removing the fibers and carbonizing the coating layers together with the residue of the fibers (if there are any). The removing treatment and carbonization treatment can be proceeded sequentially or concurrently.

This application is a continuation in part of application Ser. No. 09/985,338 filed on Nov. 2, 2001. The present invention generally relates to carbon tubes, and more particularly, a method for making two-dimension and three-dimension assembled structures of carbon tubes.

### FIELD OF THE INVENTION

### Background of the Invention

Carbon tubes have various applications in the art. General applications of carbon tubes are found in medical research, semiconductors and microelectronics. Various methods of manufacturing carbon tubes are available in the art, including carbon arc discharge, laser ablation, condensed-phase electrolysis, and catalytic pyrolysis of hydrocarbons on various substrates such as porous anodic aluminum oxide, fine metal particles, and patterned cobalt layer.

A significant function of carbon tubes is the allowance of reactants to flow through their cavities. The inner surface of the cavities in carbon tubes can be modified by chemical treatment. The chemical treatment renders the inner surface of the cavities active with desired affinity, thereby enabling selective separation or extraction of compounds. In addition, by embedding certain transition metal complexes on the inner surface of the cavities, desired catalytic functions can be implemented.

A shortcoming of conventional methods of manufacturing small-sized carbon tubes is the inability to produce a hollow carbon tube with opening ends. This shortcoming significantly limits the capability of the carbon tube for applications that utilize the inner surface and inner space of the tubes for, e.g., selective separation or extraction of compounds, catalytic reactor or micro-reactor applications. Another shortcoming of conventional methods is the inability to produce a carbon tube with appreciable length (i.e., longer than about 1 mm), while retaining control of the tube wall thickness, the inner and outer diameters of the tubes. Yet another shortcoming of conventional methods is the inability to produce two-dimension (2D) or three-dimension (3D) assembled structures of carbon tubes. These shortcomings have significant negative impact on practicing numerous, important applications of the carbon tubes.

Therefore, there is a need in the art for a method for making small-sized open-ended hollow carbon tubes of appreciate length with long-range regularity having effective control on the tube wall-thickness, the inner and outer tube-diameters thereof. There is also a need in the art for an effective method of making 2D or 3D assembled structures of carbon tubes, which would enable the design and fabrication of the actual articles or devices of carbon tubes.

### SUMMARY OF THE INVENTION

The present invention provides a carbon tube device having a two-dimension (2D) or three-dimension (3D) assembled structure of a plurality of carbonized carbon tubes that includes:

carbonized coating material;

carbonized fiber residue; and

a binding element which binds the plurality of carbonized carbon tubes.

The present invention also provides a method for making carbon tubes and their assembled structures. The method of the present invention includes the steps of:

coating a plurality of natural or synthetic fibers with a coating material, wherein the plurality of fibers are removable by thermal, solvent, or chemical treatment(s), or a combination thereof;

assembling the plurality of coated fibers into an assembled matrix having a desirable shape and/or configuration;

binding the assembled matrix with a binding agent, wherein the binding agent can chemically or physically interact with the coating material and result in enhanced binding for the coated fibers and/or the carbon tubes thereafter formed;

removing the fiber totally or partly, and carbonizing the coating layer and any residual fiber material.

According to a preferred embodiment of the present invention, a thermally removable polymer fiber and a material that is more thermally stable than the polymer fiber are provided. The polymer fiber is coated with the thermally stable material. The coating is carbonized and the polymer fiber is removed as a result of the carbonization process. Carbon tubes and/or their 2D or 3D assembled structures are then formed.

### BRIEF DESCRIPTION OF THE DRAWINGS

Other features and advantages of the present invention will be apparent from the following detailed description when read in conjunction with the accompanying drawings, in which like reference designations represent like features throughout the enumerated Figures. The drawings are not drawn to scale, unless specifically noted as such, the emphasis being placed on illustrating the principles of the present invention. In the accompanying drawings:

FIG. 1 is a flow diagram illustrating the general method of the present invention;

FIG. 2 is a flow diagram illustrating a specific embodiment of the present invention;

FIGS. 3-6 are diagrams illustrating chemicals used in various embodiments of the present invention; and

FIG. 7 illustrates the scanning electron micrographs of the cross section of an assembled cylinder of carbon tubes that was prepared according to the present invention.

### DETAILED DESCRIPTION OF THE PREFERRED EMBODIMENTS

Reference is now made in detail to an embodiment of the invention that illustrates the best mode presently contemplated by the inventors for practicing the invention. Other embodiments are also described herein.

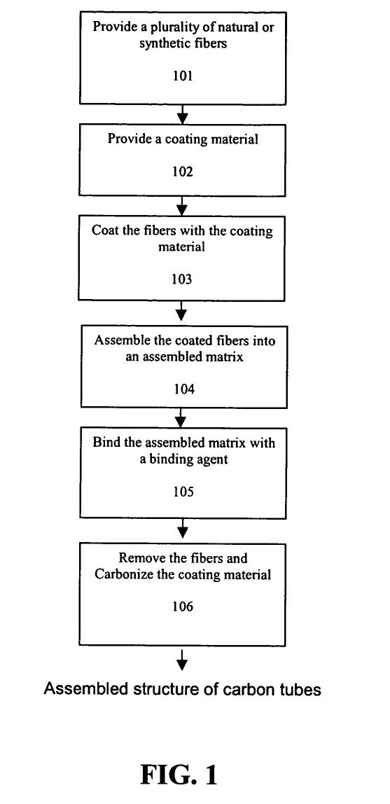

FIG. 1 is a flow diagram that illustrates the general methodology of the present invention. Referring to FIG. 1, a plurality of natural or synthetic fibers are provided as the fiber in Step 101. Referring to Step 102, a coating material is provided. The above fibers are coated with the coating material in Step 103. The coated fibers having a coating/core configuration are assembled into a matrix having a desirable shape and/or configuration in Step 104. The assembled matrix is then bound with a binding agent in Step 105. The fibers in the assembled and bound matrix are removed and the coating material is carbonized (Step 106). A 2D or 3D assembled structure of carbon tube is then formed. The diameter and the wall thickness of the carbon tubes in the assembled structure can be controlled by controlling the diameter of the corresponding core fiber and the thickness of the corresponding coating layer. The core fibers in the assembled and bound matrix in Step 106 can be removed by thermal, solvent, or chemical treatments, or a combination thereof. A thermal treatment is preferred for removing the core fiber. The coating material (Step 102) is preferred to be more thermally stable than the corresponding core fiber.

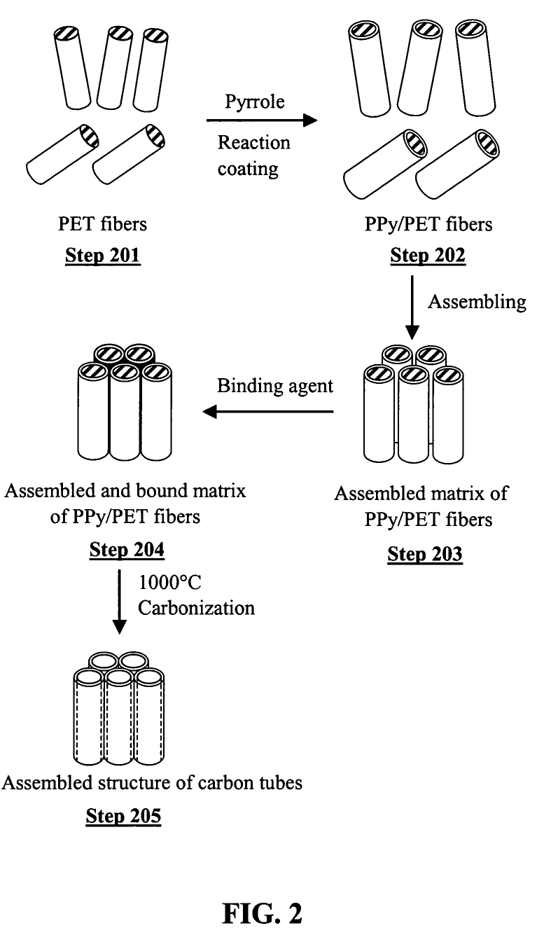

FIG. 2 is a flow diagram that illustrates a specific embodiment of the present invention. Referring to FIG. 2, a plurality of thermally removable polymer fibers such as polyethylene terephathlate (PET) are provided in Step 201. The PET serves as the growing template to produce a coated polymer fiber. Any thermally removable, natural or synthetic fiber can be used as the growing template. Natural fibers that can be used as the growing template include silk, cotton, cellulose fiber, vegetable fiber, wool, and hair. Synthetic fibers that can be used as the growing template can be made from thermoplastic and thermosetting polymers. The plurality of fibers used herein actually can present as any physical forms, such as monofilaments, yarns, a woven cloth, a non-woven fabric and as well as a preformed two-dimension (2D) or three-dimension (3D) matrix of fibers. Thermoplastic or thermosetting polymers can also be used as the coating material, provided that the selected polymer coating material is more thermally stable than the core fiber. Other thermally stable materials suitable for use as the coating material can be selected from backbone conjugated polymers.

A conjugated polymer, such as polypyrrole (PPy), is grown on a plurality of PET fibers as the coating layer to produce a plurality of composite fibers, i.e., PPy/PET fibers (Step 202). Any other material, such as organic polymers, having a higher thermal stability than that of the core fibers (e.g., the PET fibers) can also be used as the coating material. In the present embodiment, conjugated conducting polymers or polyacrylonitrile are preferred to be used as the coating material. The conjugated polymers as used in the present embodiment, can either be in the neutral, undoped forms (i.e., nonconductive form) or in the conductive, doped forms having any doping degree.

Any method suitable for preparing composite fibers having a coating/core configuration can be used, including co-extrusion, coating, and casting. The composite fiber with a similar coating/core configuration can also be prepared from a single-component material fiber, providing that the core fiber is first subjected to some chemical and/or physical pre-treatments, such as radiation-treatment to induce a cross-linking reaction on its surface, to change the chemical or physical property of its surface layer so that its core can be selectively removed by a subsequent treatment, such as by a thermal treatment, or by dissolution with a solvent. Coating methods for forming the coating on the PET include reaction coating, solution coating, dipping, casting, melt coating, spray coating, spin coating, brush coating, and thermal evaporation coating. A preferred coating method in the present embodiment is to employ a reaction coating process for preparing the composite fibers. For example, composite PET fibers having a polypyrrole coating layer can be prepared by placing the PET fibers in a reaction solution that contains pyrrole, which is the monomer of the polypyrrole (PPy) coating, and a chemical reagent for inducing the polymerization of the monomer. The PPy coating is applied by suspending the PET polymer fibers in an aqueous pyrrole solution that contains two equivalents of protonic acid, such as toluene-p-sulfonic acid. Oxidants, such as FeCl₃ or ammonium persulfate, are then added to the solution to initiate the polymerization of pyrrole. A homogeneous, dark black PPy coating is formed on the surfaces of the PET fibers, and the composite PPy/PET fibers are formed. The thickness of the PPy coating is controlled by altering the pyrrole concentration of the reaction solution, and/or by controlling the number of reaction coating treatments.

Any oxidant that is capable of inducing oxidative polymerization can be used. The nature of such oxidants varies widely depending on the monomer employed. Illustrative of oxidants for use in the present invention include ammonium persulfate, potassium persulfate, sodium persulfate, sodium dichromate, potassium permanganate, chromic acid, hydrogen peroxide, ferric chloride, potassium dichromate, and the like.

Other types of chemical reagents can also be used as long as they are capable of initiating or inducing the polymerization of the monomer. The nature of the chemical reagent varies widely depending on the monomer employed. Chemical reagents that can be used in the present invention include the reagents or initiators that initiate or induce the monomer polymerization via cationic, anionic, radical (or a combination thereof), or any other intermediates known in the art. Other useful reaction agents or chemical reagents include photon, heat, oxygen, air, moisture, or transition metal-containing catalysts.

The composite fibers with a coating/core configuration can also be formed using a solution coating method. If solution-coating is employed, a solution of the polymeric materials for the coating layer is used. For example, composite fibers having PET as the core fiber material and polyacrylonitrile as the material for the coating layer can be prepared using a solution coating process by dipping PET fibers with a polyacrylonitrile solution in DMSO (dimethylsulfoxide). The dipped fibers are then dried in air or under dynamic vacuum to form the desired composite fibers. The thickness of the coating is controlled by controlling the concentration of the polyacrylonitrile solution, the dipping rate, and the number of dipping treatments.

The coated fibers are further combined and assembled into a desired 2D or 3D assembled matrix in step 203. Any assembling methods or tools or means can be used as long as more than one fiber filaments can be held together, which include packing, weaving, knitting, netting, threading, sewing, stitching, stringing, wiring, tying, braiding, wrapping, binding, fastening, winding, and stapling. For example, PET yarns (containing about 20-30 monofilaments in each yarn) can be first coated with polypyrrole via a reaction coating method. Hundreds of such coated PET yarns can be tied together with PET fiber into an assembled fiber bundle having several thousands of composite fiber filaments packed together with their average fiber axes being more or less followed the long axis of the resultant fiber bundle. Alternatively, ten or twenty of such coated PET yarns are tied first to form a fiber bundle of smaller sizes, then tens of such small-size fiber bundles can be subsequently tied together to form a fiber bundle of larger sizes. For another example, a PET cloth can be first coated with polypyrrole via a reaction coating method. Then, several tens of such coated PET cloth can be stapled or sewed together to form a pre-designed multi-layer structure.

Such assembled matrix of coated fibers is further bound with a binding agent for enhancing the binding strength between the coated fibers in step 204. Any binding agent can be used as long as it can physically or chemically interact with the coating layer of the coated composite fibers and eventually yield a binding element in the final assembled structure of carbon tubes. Such binding element serves to enhance the binding interactions between the neighboring carbon tubes and improve the mechanical strength of the final carbon tube device. Useful binding agents may be a chemical material, including oligomers, polymers, resins, adhesives, sol gels, metal oxides, metals, ceramics, cements, epoxy resins, and a combination thereof. For example, the above-assembled bundle of PPy/PET composite fibers can be treated with a solution containing a polymer binder, such as polyacrylonitrile. After pumping to dryness, the composite fibers in the assembled matrix are coated with and bound by polyacrylonitrile. For another example, the above assembled PPy/PET cloth can be treated with an epoxy adhesive to form a multi-layer structure of composite fibers embedded in an epoxy resin. Other thermoplastic or thermosetting polymers are also useful binding agents. These assembled and bound matrix of composite fibers can be further trimmed, if needed, to the desired sizes or shapes before performing the subsequent treatment. After the subsequent carbonization treatment, such bound and assembled matrix of composite fibers will form an assembled carbon tube structure having the desired sizes and shapes. The mechanical strength of the resultant carbon tube structure is enhanced due to the presence of binding element, which helps improve the adhesion between the neighboring carbon tubes. In these cases, the effective binding element is the interfacial carbonized products resultant from the carbonization of the above polymer binding agents. Similar binding element can be obtained when other carbon-containing molecules or materials are used as the binding agents.

Other useful types of binding agents include the chemical reagents that can physically or chemically interact with the coating layer and functionalize the surfaces of the composite fibers, which will then facilitate the formation of interfacial covalent bonding interactions between the neighboring composite fibers or between the neighboring carbon tubes thereafter formed. In this case, the binding element is the interfacial covalent bonding structures formed between the contacted surfaces. A special class of such chemical reagents includes various crosslinking reagents, such as peroxide, hydroperoxide, azo compound, redox initiator, photoinitiator, sulfur, and a combination thereof.

Useful binding agents may also be in a form of an energy beam of laser or ultraviolet light or visible light or photons or high energy radiations or γ-ray or x-ray or electrons or high speed particles, or in a form of a reactive atmosphere of plasma or radical or hot air or ozone, providing that such a treatment can render the formation of interfacial covalent bonding interactions between the neighboring composite fibers. Under this circumstance, the final assembled carbon tube structure will contain a binding element comprising of the interfacial covalent bonds or bonding structures between the carbonized carbon tubes.

Other types of useful binding agents may include chemical reagents (such as small molecule chemicals, oligomers, solvents, surfactants, swelling agents, and the like) that can physically wet or swell the coated fibers totally or in part and render the neighboring composite fibers sticking to or interpenetrating into each other at their contacted surfaces. Still other useful binding agent may include an energy flux, such as a flux of microwave or infrared radiation or heat, which can melt or soften the surfaces of the composite fibers leading to a surface blending or surface interpenetrating between the neighboring composite fibers at the contacted surfaces. Such blended or interpenetrated contact surfaces will result in a fused and covalently bonded interfacial structures after the carbonization treatment, which then serve as the binding element for the carbonized and assembled structure of carbon tubes.

Useful binding agents can also include inorganic molecules or compounds or materials, providing that the final resultant binding element can serve to improve the binding interactions between the neighboring carbon tubes and enhance the mechanical strength of the resultant carbon tube structure. In these cases, the binding element is the interfacial inorganic network structure that is converted from the inorganic binding agents. Similarly, organometallic compounds or materials can also be used, as long as they are capable of forming a binding element in the final assembled carbon tube structure.

When chemical reagents or chemical materials are employed as the binding agents, they can be used in a wide variety of physical forms, such as solution, melt, neat liquid, vapor, latex, emulsion, dispersion, suspension, powder, gel, paste, and the like. There are also no limitations on the thermal property nature of the employed chemical materials. Chemical materials of a wide range of thermal stability can be used depending on the needs and purposes. When the employed chemical materials are thermally less stable than the coating layer materials, the resultant assembled carbon tube structure will contain a relatively low amount of binding elements. In the extreme cases, the resultant assembled carbon tube structures may mainly consist of individually well-defined carbon tubes that are bound or connected with each others by the above said interfacial binding elements at the contacted surfaces. When the employed chemical materials are thermally more stable than the coating layer materials, the resultant assembled carbon tube structure will contain a relatively high amount of binding elements. In the extreme cases, the resultant assembled carbon tube structures may have the resultant carbon tubes embedding in a matrix of the resultant binding elements.

Furthermore, more than one types of binding agents or binding treatment steps can be applied concurrently or sequentially if needed. For example, an assembled coated composite fibers can be first dip-coated with a solution of chemical binding agent, such as a radical initiator, followed by exposing with ultraviolet or visible light, or subjecting to a heat treatment to induce the formation of radical species, thus leading to the formation of interfacial covalent bonding interactions at the contacted surface areas between the coated composite fibers. These interfacial covalent bonds will not only result in the final binding element of the carbonized and assembled structure of carbon tubes but also very likely help promote their neighboring areas or sections to participate such interfacial binding activity, thus enlarging the dimension and/or the population of such binding element. For another example, in the binding step the coated fibers can be first treated with a metal oxide material by a sol gel process, then with a metal material using either an electroless plating or an electrochemical plating process. In this case, the resultant assembled structure of carbon tubes can contain more than one types of binding elements.

Referring to Step 205, a 2D or 3D assembled structure of a plurality of carbon tubes is formed after a carbonization process is applied. The PPy/PET fibers in the assembled and bound matrix undergo a thermal treatment, which removes the PET core fibers to form the carbon tubes. Other physical and/or chemical treatments, such as dissolution by a solvent, can also be used as long as it removes the core fibers totally or partly from the composite fibers. After the carbonization treatment, carbon tubes of appreciable length (up to several centimeters long) are then formed, with a controllable tube wall thickness ranging from less than 100 nm to several micrometers, and a tube diameter in the range of 1 to 100 micrometers.

The physical and/or chemical treatment can be a single-step process or a series of combination steps, as long as at least one of the steps removes the core fibers totally or partly to convert the composite fibers in the assembled matrix into a tube-shape material, and at least one of the steps carbonize the composite fiber to form a carbon-rich material. In the present embodiment, the assembled matrix of composite fibers is subjected to a thermal treatment, or a solvent treatment, to remove totally or partly the core fibers, followed by a thermal treatment to carbonize the remaining material of the composite fibers to form the resultant assembled matrix of carbon tubes, wherein said plurality of carbon tubes contains carbonized coating material, carbonized fiber residue, and binding element. The binding element is resulted directly or indirectly from the binding treatment. As illustrated in the above section, the nature of such binding element can vary widely, depending on the binding agent and/or the binding treatment process employed in the previous step.

As for the thermal treatment, the core fiber material can be removed by melting, subliming, vaporizing, decomposing, or any combination of such physical and/or chemical transformation(s). In the present embodiment, the assembled matrix of composite (PPy/PET) fibers is heated to a temperature at least higher than the melting and/or decomposition temperature of the core fibers. The thermal treatment process can be performed under any atmosphere as long as the composite fibers will not be totally removed. The pressure of such atmosphere can be greater or less than 1 atm (atmosphere), depending on the requirements for processing the composite fiber of different types. Preferably, the thermal treatment is performed under an inert atmosphere such as N₂, Ar, He, Ne, or a combinations thereof. The thermal treatment can also be performed under vacuum conditions. The reactive atmosphere, such as air or oxygen, can also be used in combination with the above noted atmosphere as long as such treatment can either enhance the thermal stability of the coating or facilitate the thermal decomposition of the core fiber. For instance, a composite fiber, having PET as the core material and polyacrylonitrile as the coating, is pretreated in air at 200 to 300° C. to enhance the thermal stability of the polyacrylonitrile coating. Another thermal treatment in a nitrogen atmosphere at higher temperatures is subsequently performed to remove the core PET material and carbonize the oxygen-treated polyacrylonitrile coating.

In the present embodiment, the above-assembled fibrous bundle, containing thousands of PPy/PET composite fiber filaments, was soaked with a solution of polyacrylonitrile overnight. After pumping to dryness, the resultant polyacrylonitrile-bound fibrous bundle was cut into 1 cm long cylinders, which were then subjected to a heating treatment from room temperature up to 1000° C. at a heating rate of 10 Celsius per minute (° C./min), and staying at 1000 degrees Celsius (° C.) for 3 to 24 hours in a nitrogen atmosphere with a nitrogen flow rate of 0.5 liters per minute. After the heating treatment, carbonized cylinders containing thousands of carbon tubes with main axis being roughly parallel to each other were obtained. Alternatively, the above cylinders can be pretreated at about 200-300° C. under an air atmosphere for about 30 minutes before the above carbonization treatment was performed. In both ways, the obtained carbon-tube-assembled cylinders are found to have much improved mechanical strength than the loosely packed or the individually separated carbon tubes. The much improved-mechanical strengths of the carbon-tube assembly should greatly increase the durability of the resultant articles or devices, which are believed to be particularly important for any long-term applications.

The present invention enables the preparation of 2D or 3D assembled structures of carbon tubes, enabling easier design and fabrication of carbon tube devices or articles for practical applications. The two- or three-dimensional assembled structures of carbon tubes can easily be made, up to several centimeters in length and with dramatically improved mechanical strength, using the method of the present invention. Such long range, highly regular and mechanically strong carbon tube structures are otherwise extremely difficult to obtain using conventional methods of manufacturing small-sized carbon tubes.

The micrometer-sized carbon tubes formed according to the present invention, with their relatively large inner diameter, allow reactants to easily flow through their cavities. When the inner surface is modified using chemical treatment to render the inner surface active with desired affinity, compounds can be selectively separated (or extracted). Desired transition metal complexes (with sizes often larger than 2-3 nm) can be easily embedded on the inner surface of the micrometer-sized carbon tubes to impart specific catalytic functions. The throughput of micrometer-sized carbon tube micro-reactors is optimized with the larger inner tube diameter.

The tube length, tube wall thickness and tube diameter of the carbon tubes formed according to the present invention can be controlled. The tube can be obtained in any desired length ranging from a length less than 1 nanometer to several centimeters. Note that there is no upper limit in the tube length that can be formed, so long as the core material can be effectively removed by the thermal or solvent treatment.

The tube wall thickness of the carbon tubes formed according to the present invention can be controlled by controlling the thickness of the coating of the composite fiber. According to the present invention, the tube wall thickness can be obtained in any desired size, ranging from a thickness of less than 50 nm to greater than several hundred micrometers. Carbon tubes with a wall thickness less than 50 nm can also be prepared using the method of the present invention, as long as a core fiber of less than approximately 1 micrometer in diameter is employed. Note that there is no upper limit in the tube wall thickness that can be formed, depending upon the requirements of the specific application.

The tube diameter of the carbon tubes formed according to the present invention can also be controlled by controlling the diameter of the core fiber. Any desired tube diameter can be obtained, depending on the particular natural or synthetic fiber used as the core fiber. According to the present invention, the tube diameter can be obtained in any desired size, ranging from a diameter less than 1 micrometer to greater than several hundred micrometers. Note that there is no lower or upper limit on the tube diameter that can be formed, depending on the particular material used as the core, and the requirements of the specific application.

Although the composition of the carbon tubes formed according to the present invention is rich in carbon, it is not limited to carbon composition only. Other elements can also co-exist in the carbon tubes. The amount and type of such co-existing elements can vary widely, depending on the material used and the treatment process employed for forming the carbon tubes. Preferably, the carbon tubes formed according to the present invention contain equal to or greater than approximately 40 to 60 weight percentage (wt %) of carbon. Carbon tubes that contain equal to or greater than 50-70 wt %, 60-80 wt %, and 70-90 wt % of carbon can also be formed using the method of the present invention.

The phase of the carbon material in the carbon tubes formed according to the present invention can vary widely depending on the materials used and the thermal treatment employed. The phase of the carbon materials can be amorphous, crystalline, turbostratic, graphitic or any phase combination thereof.

The carbon tubes formed according to the present invention can be used for any purpose for which carbon tubes are useful. Examples of useful applications include electron field emitters, nano- or micro-wires, nanometer- or micrometer-sized chemical probes, natural gas storage, catalytic micro-reactors and biosensors. The carbon tubes can also be used as the carbon electrodes for lithium batteries, fuel cells, electrochemical cells, and capacitors. In addition, the carbon tubes are useful as reinforcement materials. In particular, for micrometer-sized carbon tubes, with their relatively larger inner diameter, inner surface modifications can be efficiently implemented using chemical treatment to render the inner surface active, thus enabling selective separation (or extraction) of interested compounds.

A. Illustrative Examples of Thermoplastic and Thermosetting Polymers

Illustrative of organic polymers for the core fiber and the coating material for use in the present invention are thermoplastic and thermosetting polymers. Thermosetting polymers that can be used in the present invention can vary widely. Illustrative of such useful thermoset polymers are alkyds derived from the esterification of a polybasic acid such as phthalic acid and a polyhydric alcohol such as glycol; allylics such as those produced by polymerization of dialkyl phthalate, dialkyl isophthalate, dialkyl maleate, and dialkyl chlorendate; amino resins such as those produced by addition reaction between formaldehyde and such compounds as melamine, urea, aniline, ethylene urea, sulfonamide and dicyanodiamide; epoxies such as epoxy phenol novolak resins, diglycidyl ethers of bisphenol A and cycloaliphatic epoxies; phenolics such as resins derived from reaction of substituted and unsubstituted phenols such as cresol and phenol with an aldehyde such as formaldehyde and acetaldehyde; polyesters; silicones; and urethanes formed by reaction of a polyisocyanate such as 2,6-tolylene diisocyanate, 2,4-tolylene diisocyanate, 4,4-diphenylmethane diisocyanate, 1,6-hexamethylene diisocyanate and 4,4′-dicyclohexylmethane diisocyanate with a polyol such as polyether polyol (trimethylol propane, 1,2,6-hexanetriol, 2-methyl glycoside, pentaerythitol, poly(1,4-tetramethylene ether) glycol, sorbitol and sucrose), polyester polyols such as those prepared by esterification of adipic acid, phthalic acid and like carboxylic acids with an excess of difunctional alcohols such as ethylene glycol, diethylene glycol, propanediols and butanediols.

Thermoplastic polymers that can be used in the present invention vary widely. Illustrative of such thermoplastic polymers include polyesters such as poly(glycolic acid), poly(ethylene succinate), poly(ethylene adipate), poly(tetramethylene adipate), poly(ethylene azelate), poly(ethylene sebacate), poly(decamethylene adipate), poly(decamethylene sebacate), poly(1,2-dimethylpropiolactone), poly(pivaloyl lactone), poly(para-hydroxybenzoate), poly(ethylene oxybenzoate), poly(ethylene isophthalate), poly(ethylene terephthalate), poly(decamethylene terephthalate), poly(hexamethylene terephthalate), poly(1,4-cyclohexane dimethylene terephthalate), poly(ethylene-1,5-naphthalate), poly(ethylene-2,6-naphathalate), poly(1,4-cyclohexylidene dimethylene-terephthalate), and the like; polyamides such as poly(4-aminobutyric acid) (nylon 4), poly(6-aminohexanoic acid) (nylon 6), poly(7-aminoheptanoic acid) (nylon 7), poly(8-aminooctanoic acid) (nylon 8), poly(9-aminononanoic acid) (nylon 9), poly(10-aminodecanoic acid) (nylon 10), poly(11-aminoundecanoic acid) (nylon 11), poly(12-aminododecanoic acid) (nylon 12), poly(hexamethylene adipamide) (nylon 6,6), poly(heptamethylene pimelamide) (nylon 7,7), poly(octamethylene sebacamide) (nylon 8,8), poly(hexamethylene sebacamide), (nylon 6,10), poly(nonamethylene azelamide) (nylon 9,9), poly(decamethylene azelamide) (nylon 10,9), poly(decamethylene sebacamide) (nylon 10,10), poly[bis(4-aminocyclohexyl)methane-1,10-decanedicarboxamide] (Quiana) (trans), poly(m-xylene adipamide), poly(p-xylene sebacamide), poly(2,2,2-trimethylhexamethylene terephthalamide), poly(piperazine sebacamide), poly(meta-phenylene isophthalamide) (Nomex), poly(p-phenylene terephthalamide) (Kevlar), and the like; polycarbonates such as poly[methane bis(4-phenyl)carbonate], poly[1,1-ethane bis(4-phenyl)carbonate], poly[2,2-propane bis(4-phenyl)carbonate], poly[1,1-butane bis(4-phenyl)carbonate], poly[1,1-(2-methylpropane) bis(4-phenyl)carbonate], poly[2,2-butane bis(4-phenyl)carbonate], poly[2,2-pentane bis(4-phenyl)carbonate], poly[4,4-heptane bis(4-phenyl)carbonate], poly[1,1-(1-phenylethane) bis(4-phenyl)carbonate], poly[diphenylmethane bis(4-phenyl)carbonate], poly[1,1-cyclopentane bis(4-phenyl)carbonate], poly[1,1-cyclohexane bis(4-phenyl)carbonate], poly[thio bis(4-phenyl)carbonate], poly [2,2-propane bis-[4-(2-methyl phenyl)]carbonate], poly[2,2-propane bis-[4-(2-chlorophenyl)]carbonate], poly[2,2-propane bis-[4-(2,6-dichlorophenyl)]carbonate], poly[2,2-propane bis-[4-(2,6-dibromophenyl)]carbonate], poly[1,1-cyclohexane bis-[4-(2,6-dichlorophenyl)carbonate], and the like; polymers derived from the polymerization of α,β-unsaturated monomers such as polyethylene, acrylonitrile/butadiene/styrene terpolymer, polypropylene, poly(1-butene), poly(3-methyl-1-butene), poly(1-pentene), poly(4-methyl-1-pentene), poly(1-hexene), poly(5-methyl-1-hexene), poly(1-octadecene), polyisobutylene, poly(isoprene), 1,2-poly(1,3-butadiene) (isotatic), 1,2-poly(1,3-butadiene) (syndiotatic), polystyrene, poly(α-methylstyrene), poly(2-methylstyrene), poly(4-methylstyrene), poly(4-methoxystyrene), poly(4-phenylstyrene), poly(3-phenyl-1-propene), poly(2-chlorostyrene), poly(4-chlorostyrene), poly(vinyl fluoride), poly(vinyl chloride), poly(vinyl bromide), poly(vinylidene fluoride), poly(vinylidene chloride), poly(tetrafluoroethylene) (Teflon), poly(chlorotrifluoroethylene), poly(vinyl cyclopentane), poly(vinyl cyclohexane), poly(α-vinyl naphthalene), poly(vinyl alcohol), poly(vinyl methyl ether), poly(vinyl ethyl ether), poly(vinyl propyl ether), poly(vinyl isopropyl ether), poly(vinyl butyl ether), poly(vinyl isobutyl ether), poly(vinyl sec-butyl ether), poly(vinyl tert-butyl ether), poly(vinyl hexyl ether), poly(vinyl octyl ether), poly(vinyl methyl ketone), poly(methyl isopropenyl ketone), poly(vinyl formate), poly(vinyl acetate), poly(vinyl propionate), poly(vinyl chloroacetate), poly(vinyl trifluoroacetate), poly(vinyl benzoate), poly(2-vinyl pyridine), poly(vinyl pyrrolidinone), poly(vinyl carbazole), poly(acrylic acid), poly(methyl acrylate), poly(ethyl acrylate), poly(propyl acrylate), poly(iso-propyl acrylate), poly(butyl acrylate), poly(isobutyl acrylate), poly(sec-butyl acrylate), poly(tert-butyl acrylate), poly(methacrylic acid), poly(methyl methacrylate), poly(ethyl methacrylate), poly(propyl methacrylate), poly(isopropyl methacrylate), poly(butyl methacrylate), poly(isobutyl methacrylate), poly(sec-butyl methacrylate), poly(tert-butyl methacrylate), poly(2-ethylbutyl methacrylate), poly(hexyl methacrylate), poly(octyl methacrylate), poly(dodecyl methacrylate), poly(octadecyl methacrylate), poly(phenyl methacrylate), poly(benzyl methacrylate), poly(cyclohexyl methacrylate), poly(methyl chloroacrylate), polyacrylonitrile, polymethacrylonitrile, polyacrylamide, poly(N-isopropylacrylamide), and the like; polydienes such as poly(1,3-butadiene) (cis), poly(1,3-butadiene)(trans), poly(1,3-butadiene)(mixt.), poly(1,3-pentadiene)(trans), poly(2-methyl-1,3-butadiene) (cis), poly(2-methyl-1,3-butadiene) (trans), poly(2-methyl-1,3-butadiene)(mixt.), poly(2-tert-butyl-1,3-butadiene)(cis), poly(2-chloro-1,3-butadiene)(trans), poly(2-chloro-1,3-butadiene) (mixt.) and the like; polyoxides such as poly(methylene oxide), poly(ethylene oxide), poly(tetra-methylene oxide) poly(ethylene formal), poly(tetra-methylene formal), polyacetaldehyde, poly(propylene oxide), poly(hexene oxide), poly(octene oxide), poly(trans-2-butene oxide), poly(styrene oxide), poly(3-methoxypropylene oxide), poly(3-butoxypropylene oxide), poly(3-hexoxypropylene oxide), poly(3-phenoxy-propylene oxide), poly(3-chloropropylene oxide), poly[2,2-bis(chloromethyl)-trimethylene-3-oxide] (penton), poly(2,6-dimethyl-1,4-phenylene oxide) (PPO), poly(2,6-diphenyl-1,4-phenylene oxide) (Texax, P30), and the like; polysulphides such as poly(propylene sulphide), poly(phenylene sulphide), and the like; polysulfones such as poly[4,4′-isopropylidene diphenoxy di(4-phenylene) sulphone]; noryl; and mixtures thereof.

In the preferred embodiments of the present invention, the useful organic polymer is a thermoplastic homopolymer or copolymer. Preferred thermoplastic polymers are nylons, polyesters, polycarbonates, poly(α-olefins), acrylics, methacrylics, substituted and unsubstituted polybutadienes, poly(vinyl halides), polysulfones, polyvinyl ethers, polyvinyl esters, poly(vinyl aromatics), poly(ethylene oxides), poly(vinyl alcohols), poly(vinyl acetates), and acrylonitrile/butadiene/styrene terpolymer.

More preferred thermoplastic substituted or unsubstituted homopolymer, or substituted or unsubstituted copolymers include substituted or unsubstituted nylons, substituted or unsubstituted polycarbonates, substituted or unsubstituted polyesters, substituted or unsubstituted poly(α-olefins), substituted or unsubstituted chlorinated poly(α-olefins), substituted or unsubstituted poly(butadienes), substituted or unsubstituted poly(vinyl halides), substituted or unsubstituted polysulfones, substituted or unsubstituted poly(vinyl ethers), substituted or unsubstituted poly(vinyl acetates), substituted or unsubstituted poly(vinyl alcohols), substituted or unsubstituted poly(ethylene oxides), acrylonitrile/butadiene/styrene terpolymer, substituted or unsubstituted polystyrenes; and most preferred thermoplastic polymers are poly(ethylene terephthalate), nylon-6, nylon-6,6, nylon-12, polycarbonate, poly(vinyl chloride), poly(chlorotrifluoroethylene), polyethylene terephthalate glycol, polyethylene, polypropylene, chlorinated polyethylene or polypropylene, polyisobutylene, polybutadiene, polystyrene, polyethylene oxide, acrylonitrile/butadiene/styrene terpolymer (ABS).

B. Illustrative Examples of Conjugated Conducting Polymer

Other preferred coating materials for the core fibers are electrically conductive backbone conjugated homopolymers or copolymers. Illustrative of such polymers are poly(unsaturated) polymers such as substituted or unsubstituted polyacetylenes; substituted or unsubstituted polyarylacetylenes; substituted or unsubstituted poly(heteroaromatics), such as polythiophenes, poly(furans), polypyrroles, polyquinolines, polyisothianaphthenes, polycarbazoles, poly(alkyl thiophenes) and the like; substituted or unsubstituted poly(aromatics) such as polyphenylene sulfides, polyanilines, polyphenylenes, polynaphthalenes, and polyperinaphthalenes, poly(azulenes) and the like; and substituted or unsubstituted poly(aromatic vinylenes) such as poly(phenylene vinylenes), poly(dimethoxy phenylene vinylenes), poly(naphthalene vinylenes) and the like; and substituted or unsubstituted poly(heteroaromatic vinylenes) such as poly(thienylene vinylenes), poly(furylene vinylenes), poly(carbazole vinylenes), poly(pyrrole vinylenes) and the like.

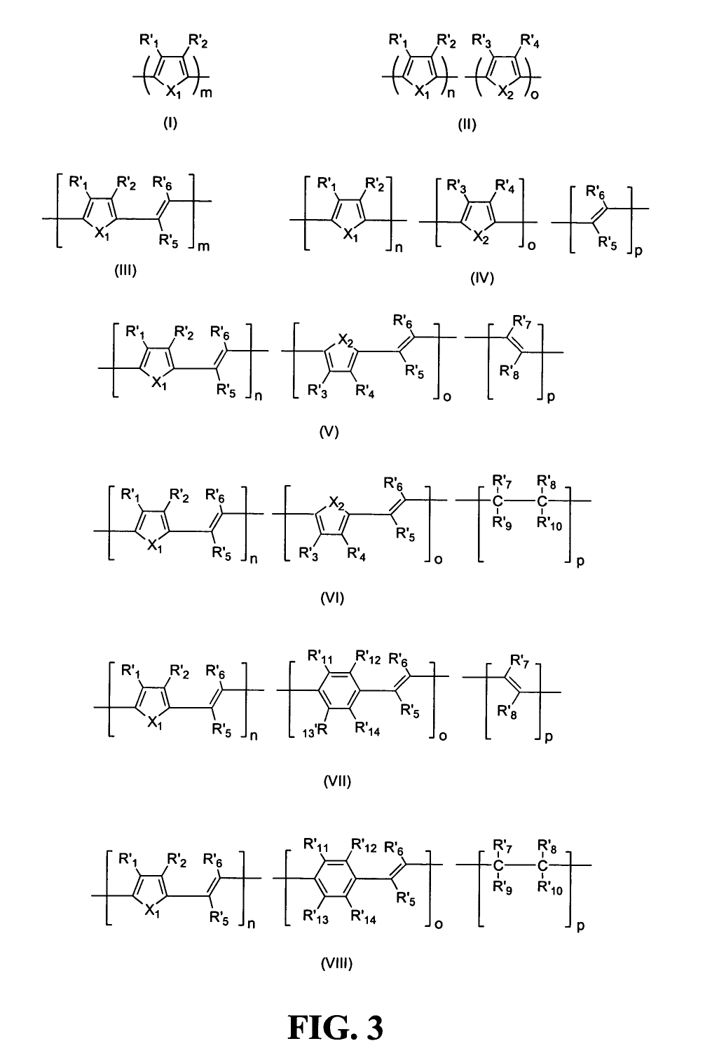

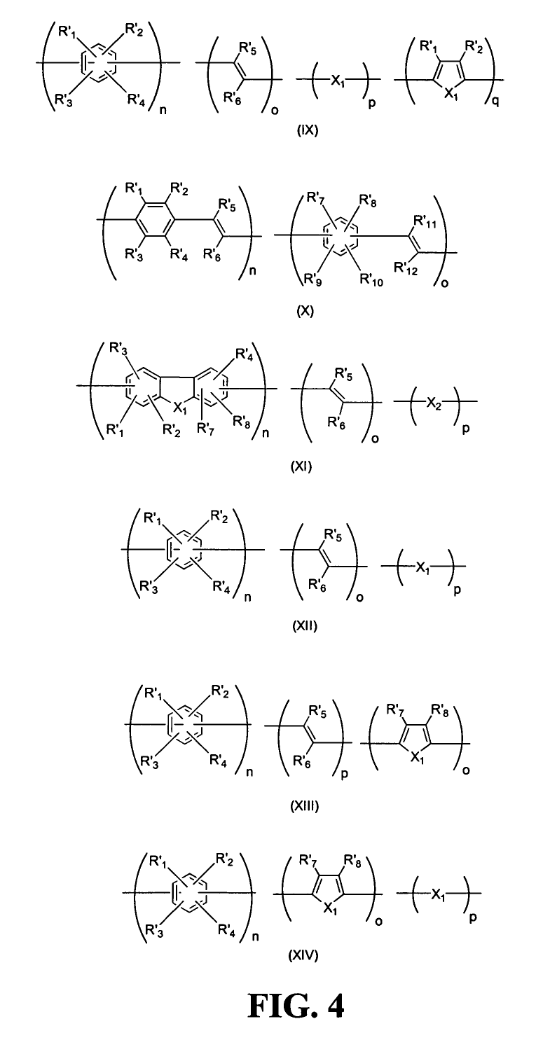

Preferred conjugated backbone homopolymer or copolymers are substituted or unsubstituted polyanilines, substituted or unsubstituted polyacetylenes, substituted or unsubstituted polyarylacetylenes, substituted or unsubstituted polypyrroles, substituted or unsubstituted poly(heterocycles), substituted or unsubstituted aromatic vinylenes, and substituted or unsubstituted heteroaromatic vinylenes. Illustrative of preferred homopolymers or copolymers of heterocycles, and aromatic or heteraromatic vinylenes are those comprising moieties of the Formulas I to XIV of FIGS. 3 and 4:

wherein:

m, and the sum of n, o, p and q are the same or different and are integers at least about 10,

with the proviso that at least one of n or o is greater than zero;

R′₁, R′₂, R′₃, R′₄, R′₅, R′₆, R′₇,R′₈, R′₉, R′₁₀, R′₁₁, R′₁₂, R′₁₃, and R′₁₄ are the same or different at each occurrence and are hydrogen or isotopes thereof, hydroxyl, alkyl, alkenyl, aryl, alkoxy, cycloalkyl, cycloalkenyl, alkanoyl, alkylthio, aryloxy, alkylthioalkyl, alkynyl, alkylaryl, arylalkyl, amido, alkylsulfonyl, alkoxyalkyl, alkylsulfinyl, aryl, arylamino, diarylamino, alkylamino, dialkylamino, alkylarylamino, arylthio, heteroaryl, arylsulfinyl, alkoxycarbonyl, arylsulfonyl, acid functional groups such as sulfonic acid, carboxylic acid, phosphonic acid, phosphinic acid, phosphoric acid, sulfinic acid, and the derivatives thereof such as salts, esters and the like; halogen, nitro, cyano, or alkyl or phenyl substituted with one or more of acid functional groups such as sulfonic acid, carboxylic acid, phosphonic acid, phosphoric acid, phosphinic acid, sulfinic acid, and the derivatives thereof such as salts, esters, and the like; halo, amino, nitro, hydroxyl, cyano, or epoxy moieties, or derivatives of a moiety of the formula:

—(OR′₁₅)ᵣOR′₁₆

wherein:

R′₁₅ is a divalent alkylene moiety having from 1 to about 7 carbon atoms;

R′₁₆ is alkyl having from 1 to about 20 carbon atoms; and

r is a natural number from 1 to about 50; or

R′₁ and R′₂, or R′₃ and R′₄, or R′₅ and R′₆, or R′₇ and R′₈, or R′₉ and R′₁₀, or R′₁₁ and R′₁₂, or R′₁₃ and R′₁₄ substituents taken together may form an alkylene or alkenylene or alkynylene group completing a 3, 4, 5, 6, 7, 8, 9 or 10 membered aromatic or alicyclic carbon ring, which ring may optionally include one or more degrees of unsaturation or one or more heteroatoms of nitrogen, sulfur, phosphorus, selenium, sulfinyl, sulfonyl or oxygen; and

X₁ and X₂ are the same or different and are S, O, Se, NR′₁₇, PR′₁₇ or CR′₁₇R′₁₈, wherein R′₁₇ and R′₁₈ are hydrogen, alkylaryl, arylalkyl, alkyl or R′₁.

Illustrative of useful R′₁, R′₂, R′₃, R′₄, R′₅, R′₆, R′₇, R′₈, R′₉, R′₁₀, R′₁₁, R′₁₂, R′₁₃, and R′₁₄ groups are hydrogen; hydroxyl; cyano; nitro; halo; alkyl such as methyl, ethyl, butyl, pentyl, octyl, nonyl, tert-butyl, neopentyl, isopropyl, sec-butyl, dodecyl and the like; alkenyl such as 1-propenyl, 4-butenyl, 1-pentenyl, 6-hexenyl, 1-heptenyl, 8-octenyl and the like; alkoxy such as propoxy, butoxy, methoxy, isopropoxy, pentoxy, nonyloxy, ethoxy, octyloxy and the like; alkanoyl such as butanoyl, pentanoyl, octanoyl, ethanoyl, propanoyl and the like; arylamino and diarylamino such as phenylamino, diphenylamino and the like; alkylsulfinyl, alkylsulfonyl, alkylthio, arylsulfonyl, arylthio and the like; such as butylthio, neopentylthio, methylsulfinyl, benzylsulfinyl, phenylsulfinyl, propylthio, octylthio, nonylsulfonyl, octylsulfonyl, methylthio, isopropylthio, phenylsulfonyl, methylsulfonyl, nonylthio, phenylthio, ethylthio, benzylthio, phenethylthio, sec-butylthio, naphthylthio and the like; alkoxycarbonyl such as methoxycarbonyl, ethoxycarbonyl, butoxycarbonyl and the like; alkylamino and dialkylamino such as dimethylamino, methylamino, diethylamino, ethylamino, dibutylamino, butylamino and the like; cycloalkyl such as cyclohexyl, cyclopentyl, cyclooctyl, cycloheptyl and the like; alkoxyalkyl such as methoxymethylene, ethoxymethylene, butoxymethylene, propoxyethylene, pentoxybutylene and the like; arylalkylamino such as methylphenylamino, ethylphenylamino and the like; aryloxyalkyl and aryloxyaryl such as phenoxyphenylene, phenoxymethylene and the like; and various substituted alkyl and aryl groups such as 1-hydroxybutyl, 1-aminobutyl, 1-hydroxylpropyl, 1-hydroxypentyl, 1-hydroxyoctyl, 1-hydroxyethyl, 2-nitroethyl, trifluoromethyl, 3,4-epoxy-butyl, cyanomethyl, 3-chloropropyl, 4-nitrophenyl, 3-cyanophenyl, 1-hydroxymethyl, and the like; hydroxyl-terminated alkyl and aryl groups such as 2-hydroxy ethyl, 4-hydroxy butyl and 4-hydroxy phenyl; sulfonic acid or carboxylic acid or phosphonic acid terminated alkyl and aryl groups such as ethylsulfonic acid, propylsulfonic acid, butylsulfonic acid, phenylsulfonic acid, and the corresponding carboxylic and phosphonic acids and derivatives of said sulfonic, carboxylic and phosphonic acids as for example salts, esters and the like. Exemplary of other useful R′₁ to R′₁₄ groups are moieties of the formula:

—(OR′₁₅)ᵣOR′₁₆

where r, R′₁₅ and R′₁₆ are as described above. Useful R′₁₅ groups include divalent moieties of the formulas —(CH₂)₂—, —(CH₂)₃—, —(CH₂)₄—, and —(CH₂CH(CH₃))—, and useful R′₁₆ groups include —CH₃, —CH₂CH₃ and —(CH₂)₈CH₃. Illustrative of substituents having such R′₁₅ and R′₁₆ are ethyleneglycol monomethylether, diethylene glycol monomethylether, triethylene glycol monomethylether, tetraethylene glycol monomethylether and the like.

Illustrative of R′₁₇ groups are hydrogen, methyl, ethyl, propyl, hexyl, octyl, nonyl, phenyl, benzyl, vinyl, allyl, dodecylphenyl, phenethyl, phenylpropyl, 2,4-dimethylphenyl, 4-methylphenyl and the like.

Preferred polymers for use in the practice of this invention are homopolymers, and random or block copolymers of the above Formulas I to XIV of FIGS. 3 and 4 in which:

m, and the sum of n, o, p and q are natural numbers at least about 20, with the proviso that at least one of n or o is not zero;

R′₁, R′₂, R′₃, and R′₄ are the same or different at each occurrence and are hydrogen or hydroxyl or alkyl having from 1 to about 20 carbon atoms, such as methyl, ethyl, propyl, isopropyl, n-butyl, sec-butyl, isobutyl, n-pentyl, isopentyl, sec-pentyl, tert-pentyl, n-hexyl, n-octyl, n-nonyl, n-decyl, and n-dodecyl; phenyl; alkylphenyl such as 2,4-dimethylphenyl, 4-methylphenyl, 4-ethylphenyl, and 4-butylphenyl; phenylalkyl such as benzyl, phenethyl; alkxoy having from 1 to about 12 carbon atoms such as methoxy, ethoxy, and propoxy; alkanoyl having from 1 to 20 carbon atoms such as formyl, acetyl, and propionyl; alkylthio, having from 1 to 20 carbon atoms such as methylthio, ethylthio, propylthio, dodecylthio and butylthio; alkoxyalkyl having from 1 to 20 carbon atoms such methoxymethyl, ethoxyethyl and heptoxypropyl; alkenyl having from 1 to about 20 carbon atoms such as allyl, vinyl and 3-butenyl; or aryl and alkyl substituted with phosphonic acid and derivatives thereof, cyano, nitro, epoxy, hydroxyl, carboxylic acid and derivatives thereof, sulfonic acid and derivatives thereof, or halo substituents, such as trifluoromethyl, 3,4-epoxybutyl, cyanomethyl, 2-nitroethyl, 3-chloropropyl, 4-nitrophenyl, hydroxyethyl, —CH₂CH₂CH₂SO₃H; —CH₂CH₂CH₂P(O)(OH)₂; and —CH₂CH₂CH₂CO₂H; or moiety of the formula:

—(OR′₁₅)ᵣOR′₁₆

wherein:

R′₁₅ is divalent alkylene having from 1 to about 4 carbon atoms;

R′₁₆ is alkyl having from 1 to about 10 carbon atoms; and

r is a natural number from 1 to about 25 such as ethylene glycol monomethylether and the like; or any of R′₁ and R′₂, or R′₃ and R′₄, substituents taken together may form an alkylene, alkenylene or alkynylene chain having from 2 to 20 carbon atoms completing a 4, 5, 6, 7, 8, 9 or 10 membered ring system(s) which may include one or more degrees of unsaturation or one or more heteroatoms of oxygen, nitrogen or sulfur such as 1,4-butanediyl, 1,2-ethanediyl, —CH₂SCH₂—, —CH₂OCH₂—, —CH₂CH₂—NH—CH₂—, or —CH₂—CH₂—N═CH—; R′₅ to R′₁₄ are the same or different at each occurrence and are hydrogen, hydroxyl, alkyl having from 1 to about 12 carbon atoms, phenyl, alkylthio having from 1 to about 12 carbon atoms, alkoxy having from 1 to about 12 carbon atoms, alkoxyalkyl having from 2 to about 12 carbon atoms, alkylamino having about 1 to about 12 carbon atoms; alkyl or phenyl substituted with hydroxyl or acid functional groups such as sulfonic acid, carboxylic acid, phosphonic acid, phosphoric acid, phosphinic acid, sulfinic acid, and the derivatives thereof such as salts, esters and the like; cyano, nitro, epoxy, or halo substituents; or any of R′₅ and R′₆, or R′₇ and R′₈, or R′₉ and R′₁₀, or R′₁₁ and R′₁₂, or R′₁₃ and R′₁₄ substituents together may form an alkenylene or alkynylene or alkylene chain having 2 to about 20 carbon atoms completing a 4, 5, 6, 7, 8, 9, or 10 membered ring system(s) which may include one or more degrees of unsaturation or one or more heteroatoms of oxygen, sulfur, or nitrogen such as 1,4-butanediyl, 1,2-ethanediyl, —CH₂SCH₂—, or —CH₂OCH₂—; and

X₁ and X₂ are the same or different and are oxygen, sulfur, NR′₁₇ or CR′₁₇R′₁₈, wherein R′₁₇ and R′₁₈ are hydrogen or alkyl or aryl.

Preferred for use in the practice of this invention are homopolymers and random copolymers of the above-referenced Formula I to XIV, wherein:

m, and the sum of n, o, p and q are at least about 40 with the proviso that at least one of n or o is not zero;

R′₁, R′₂, R′₃ and R′₄ are the same or different at each occurrence and are hydrogen; hydroxyl; alkyl having from 1 to about 12 carbon atoms such as ethyl, methyl, propyl, n-butyl, sec-butyl, n-hexyl, n-octyl, and n-dodecyl; phenyl; alkoxy or alkylthio having from 1 to about 12 carbon atoms such as methylthio, ethylthio, propylthio, butylthio, methoxy, ethoxy, and butoxy; alkoxyalkyl having from 1 to about 12 carbon atoms; or a moiety of the formula:

—(OR′₁₅)ᵣOR′₁₆

wherein:

R′₁₅ is alkylene of about 2 to 3 carbon atoms;

R′₁₆ is alkyl of from 1 to about 10 carbon atoms; and

r is a natural number from 1 to about 10;

R′₅, R′₆, R′₇, R′₈, R′₉, R′₁₀, R′₁₁, R′₁₂, R′₁₃ and R′₁₄ are the same or different at each occurrence and are hydrogen; hydroxyl; alkyl such as methyl, ethyl, or the like; substituted alkyl such as butylsulfonic acid, propylsulfonic acid, cyanomethyl, epoxybutyl, pentafluoroethyl, nitropropyl, and butylcarboxylic acid; alkoxy such as methoxy, ethoxy, butoxy, and the like; and alkylthio such as methylthio, ethylthio, and the like; or any of R′₅ and R′₆, R′₇ and R′₈, R′₉ and R′₁₀, or R′₁₁ and R′₁₂, or R′₁₃ and R′₁₄ together may be an alkenylene or alkylene chain forming an alicyclic, aromatic or heteroaromatic ring;

X₁, and X₂ are the same or different and are oxygen, sulfur, NR′₁₇ or CR′₁₇R′₁₈ wherein R′₁₇ and R′₁₈ are hydrogen or alkyl having from 1 to about 10 carbon atoms.

Among the embodiments, preferred are copolymers and homopolymers of Formula I to XIV in which:

m, or the sum of n, o, p and q is at least about 50 with the proviso that at least one of n or o is not zero;

R′₁ to R′₄ are the same or different at each occurrence and are hydrogen, alkyl, alkoxy, or

—(OR′₁₅)ᵣOR′₁₆

wherein:

R′₁₅ is —(CH₂)₂— or —(CH₂CH(CH₃))—;

R′₁₆ is —CH₃ or —CH₂CH₃; and

r is a natural number 1 to about 6;

R′₅, R′₆, R′₇, R′₈, R′₉, R′₁₀, R′₁₁, R′₁₂, R′₁₃ and R′₁₄, are the same or different at each occurrence and are hydrogen, hydroxyl, alkyl, alkoxy, or any of R′₅ and R′₆, R′₇ and R′₈, R′₉ and R′₁₀, or R′₁₁ and R′₁₂, or R′₁₃ and R′₁₄ together may form a divalent alkylene or alkenylene chain forming an alicyclic, aromatic and/or heteroaromatic ring; and

X₁, and X₂ are sulfur, NR′₁₇ or CR′₁₇R′₁₈ wherein R′₁₇ and R′₁₈ are hydrogen or alkyl having from 1 to about 7 carbon atoms.

Still other preferred electrically conductive polymers are polyanilines. As used herein, “polyanilines” are homopolymers or copolymers in which at least 50 mole % of the recurring backbone monomeric units in varying ratio are selected from the group consisting of substituted or unsubstituted phenyl rings and amine linkages (—NH— or —NR— where R is substituent other than hydrogen) with varying amounts of substituted or unsubstituted quinoid rings and imine (—N═) linkages.

Any form of such polyanilines can be conveniently used in the practice of this invention. Illustrative of useful forms are those described in Green, A. G. and Woodhead, A. E., “CXVII-Aniline-black and Allied Compounds, Part II”, J. Chem. Soc. 101, pp. 1117 (1912), and in Kobayashi, et al., “Electrochemical Reactions . . . of Polyaniline Film-Coated Electrodes”, J. Electroanal. Chem., 177, pp. 281-91 (1984), and in Shacklette, L. W., et al. “Structure and Properties of Polyaniline as Modeled by Single-Crystal Oligomers”, J. Chem. Phys., 88, pp. 3955 (1988), which are hereby incorporated by references.

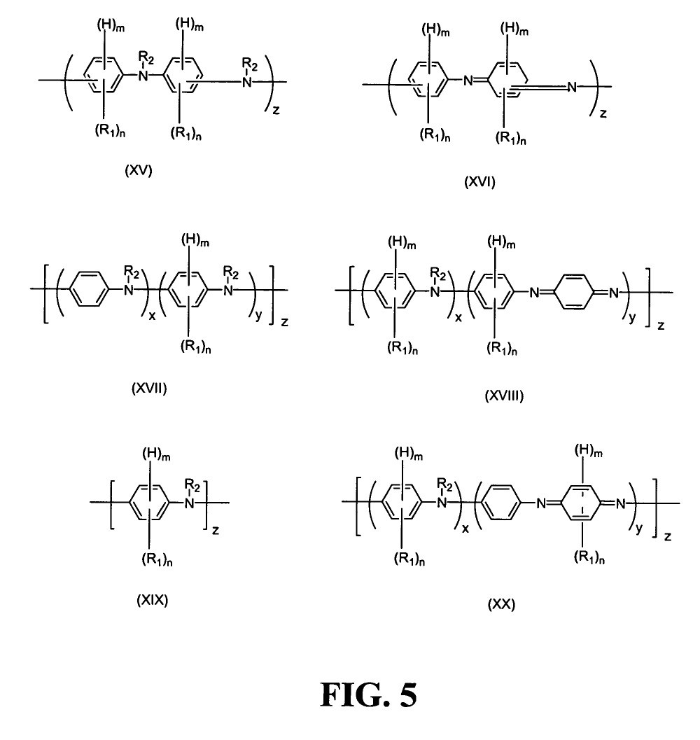

In the preferred embodiments, the polymer is polyaniline. As used herein, the polyaniline consists of repeat units of the Formulas XV or XVI of FIG. 5, a combination thereof having various ratios of the above repeat units in the polyaniline backbone such as leucoemeraldine, protoemeraldine, emeraldine, nigraniline and pernigraniline.

Illustrative of these preferred polyanilines useful in the practice of this invention are those of the Formulas XVII to XX of FIG. 5;

wherein:

n, m, R₁ and R₂ are as described above;

x and y are the same or different at each occurrence and are integers equal to or greater than 0, with the proviso that the sum of x and y is greater than 0, preferably were x is an integer equal to or greater than 0 and/or that the ratio of x to y is greater than or equal to about 0, more preferably said ratio is equal to or greater than 0.5 and most preferably said ratio is equal to or greater than about 1; and

z is the same or different at each occurrence and is an integer equal to or greater than 1.

Preferred for use in the practice of this invention are polyanilines of the above Formulas XVII to XX in which:

n is an integer from 0 to about 4;

m is an integer from 0 to 4, with the proviso that the sum of n and m is equal to 4;

R₁ is alkyl, aryl, arylthio, alkylthio or alkoxy having from 1 to about 30 carbon atoms, sulfinic acid, sulfinate, sulfinic acid salt, amino, alkylamino, dialkylamino, arylamino, diarylamino, hydroxyamino, hydroxy, nitro, phosphinate alkylsulfonyl, arylsulfonyl, sulfonic acid, sulfonate, phosphinic acid, phosphinic acid salt, phosphinate, carboxylic acid, carboxylate, phosphonic acid, phosphonate, phosphonic acid salt, cyano, halo; or alkyl, aryl, arylthio, alkylthio or alkoxy substituted with one or more phosphonic acid, phosphoric acid, borate, sulfonate, carboxylate, phosphonate, phosphonic acid salt, boric acid, phosphinic acid, phosphinate, phosphinic acid salt, sulfinic acid, sulfinate, sulfinic acid salt, carboxylic acid or sulfonic acid substituents;

R₂ is the same or different at each occurrence and is hydrogen, R₁, alkyl, aryl, or aryl or alkyl substituted with sulfonic acid, sulfonate, phosphinic acid, phsophinate, phosphonic acid salt, carboxylic acid, carboxylate, sulfinic acid, sulfinate, sulfinic acid salt, boric acid, borate, phosphonic acid, phosphonate, phosphonic acid salt substituents;

x is an integer equal to or greater than 1;

y is equal to or greater than 0, with the proviso that the ratio of x to y is equal to or greater than 0;

z is an integer equal to or greater than about 5;

Particularly preferred for use in the practice of this invention are polyanilines of the above Formulas XVII to XX in which:

n is an integer from 0 to 2;

m is an integer from 2 to 4, with the proviso that the sum of n and m is equal to 4;

R₁ is alkyl, alkoxy, arylthio, alkythio, amino, alkylamino, dialkylamino, arylamino, diarylamino, hydroxyamino, hydroxy, alkylsulfonyl, arylsulfonyl, carboxylic acid, carboxylate, phosphinic acid salt, phosphinic acid, sulfonic acid, sulfonate, sulfinic acid, phosphonic acid, sulfinic acid salt, phosphonic acid salt; or alkyl substituted with carboxylic acid, phosphinic acid, sulfinic acid, phosphinic acid salt, halo, sulfinic acid salt, sulfonate, carboxylate, phosphonic acid, phosphonic acid salt, or sulfonic acid substituents; wherein the aliphatic components of R₁ substituents include from 1 to about 30 carbon atoms and the aryl components of any R₁ substituent include from 6 to about 30 carbon atoms;

R₂ is the same or different at each occurrence and is hydrogen or R₂, alkyl, hydroxy, alkylsulfonyl, arylsulfonyl, or R₂, or alkyl substituted with one or more carboxylic acid, sulfinic acid, sulfinic acid salt, carboxylate, phosphinic acid salt, phosphinic acid, sulfonic acid, sulfinate salt, phosphonic acid or phosphonic acid salt substituents; wherein the aliphatic components of any R₂ substituent include from 1 to about 30 carbon atoms and the aryl components of any R₂ substituent include from 6 to 30 carbon atoms;

x is an integer equal to or greater than 2;

y is equal to or greater than 0, with the proviso that the ratio of x to y is greater than about 1; and

z is an integer equal to or greater than about 10.

In the preferred embodiments of this invention, the polyaniline is derived from aniline or N-alkylaniline either unsubstituted or substituted with at least one sulfonate, sulfonic acid, alkyl, alkylthio or alkoxy.

In general, the number of repeat units in the conjugated backbone homopolymer or copolymer repeat units are not critical and may vary widely. The greater the number of repeat units the greater the viscosity and molecular weight of the conjugated backbone homopolymer or copolymer. In those applications where a conjugated backbone homopolymer or copolymer of relatively low molecular weight and viscosity is required, such materials may be used, and in those applications where a conjugated backbone homopolymer or copolymer of relatively high molecular weight and viscosity is required, then such materials can be used. The number of repeat units is at least about 10. The upper limit can vary widely depending on the desired molecular weight and viscosity and the required degree of processibility, such as melt processibility, solution processibility and the like. In the preferred embodiments of the invention, the number of repeat units is at least about 20, and in the particularly preferred embodiments, the number of repeat units is at least about 30. Amongst the particularly preferred embodiments, most preferred are those embodiments in which the number of repeat units is at least about 40.

Conjugated backbone homopolymers and copolymers can be conveniently prepared through conventional procedures. Such procedures are well known in the art and will not be described herein in great detail. See for example U.S. Pat. Nos. 4,940,640; 4,711,742; 4,521,589; 4,808,681; 4,983,322; 5,006,278 and 4,900,782 and “The Handbook of Conducting Polymers”, edited by Terje A. Skotheim, Marcell Dikker, Inc. New York and Basel and references cited therein, all of which is hereby incorporated by reference. For example, preferred polyanilines can be prepared through use of chemical and electrochemical synthetic procedures. For example, one form of polyaniline can be prepared by treating aniline with ammonium persulfate (NH₄)₂S₂O₈ in excess 1M HCl. This powdered form of polyaniline is blue green in color. After methanol washing and air drying this material exhibits a conductivity of about 5 S/cm. This conductive form of polyaniline can be treated with ammonium hydroxide in ethanol to form a non-conductive form of polyaniline which is purple in color and which has a conductivity of less than 10⁻¹⁰ S/cm. Other chemical procedures for preparation of various chemical forms of polyaniline are described in detail in Green et al and U.S. Pat. Nos. 4,855,361, 4,798,685, 4,806,271, 4,822,638, 4,851,487 and 4,940,517. Likewise, unsubstituted polypyrrole can also be prepared by treating pyrrole with ammonium persulfate, (NH₄)₂S₂O₈, or with ferric chloride (FeCl₃) in excess 1M HCl.

Useful forms of polyaniline, polypyrrole or other conducting polymers (such as polyaromatics or polyheteroaromatics) can also be prepared electrochemically. For example, useful forms of polyaniline or polypyrrole can be prepared by the electrochemical oxidation of aniline or pyrrole, respectively, in aqueous fluoroboric acid electrolyte on a platinum foil anode.

Other chemical and electrochemical syntheses and transformations of polyaniline, polypyrrole or other conducting polymers may be discovered and are presently contemplated as being useful. Moreover, additional forms or types of polyaniline may be elucidated in the future. Accordingly, no limitation to the syntheses, transformation, or structures herein described or postulated is intended beyond the limitations or equivalents of the appended claims.

The conjugated backbone homopolymer or copolymer, as used in this invention, can be either in the neutral undoped (nonconductive) form(s) or in the conductive and doped forms with various doping degrees.

In the case of conductive and doped forms, the conjugated backbone homopolymer or copolymer can be doped with a suitable dopant to render the polymer electrically conductive. Dopants for use in general can be such materials which are known in the art for use in doping conjugated backbone homopolymer or copolymers to form conductive or semi-conductive polymers, such as oxidizing dopants can be used. Illustrative of useful oxidizing dopants are AsF₅, NO⁺ and NO₂⁺ salts (such as NOBF₄, NOPF₆, NOSbF₆, NOAsF₆, NO₂BF₄, NO₂PF₆, NO₂AₛF₆, NO₂SbF₆, and the like), HClO₄, HNO₃, H₂SO₄, SO₃, I₂, and Fe(III) salts (such as FeCl₃, Fe(OTs)₃, Fe (CF₃SO₃)₃, and the like). Illustrative of other dopants are protonic acid dopants. Such dopants include inorganic acids, such as hydrofluoric acid, hydroiodic acid, phosphoric acid, nitric acid, boric acid, sulfuric acid and the like. Other protonic acid dopants are organic acids, such as aryl or alkyl compounds containing sulfonic acid, sulfinic acid, carboxylic acid, phosphonic acid, phosphinic acid, or boric acid moieties.

C. Illustrative Examples of Monomers for Reaction Coating

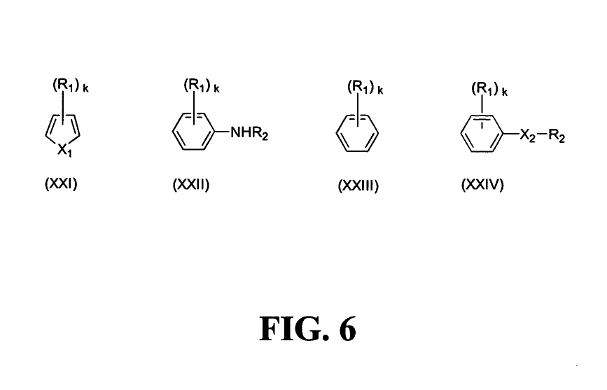

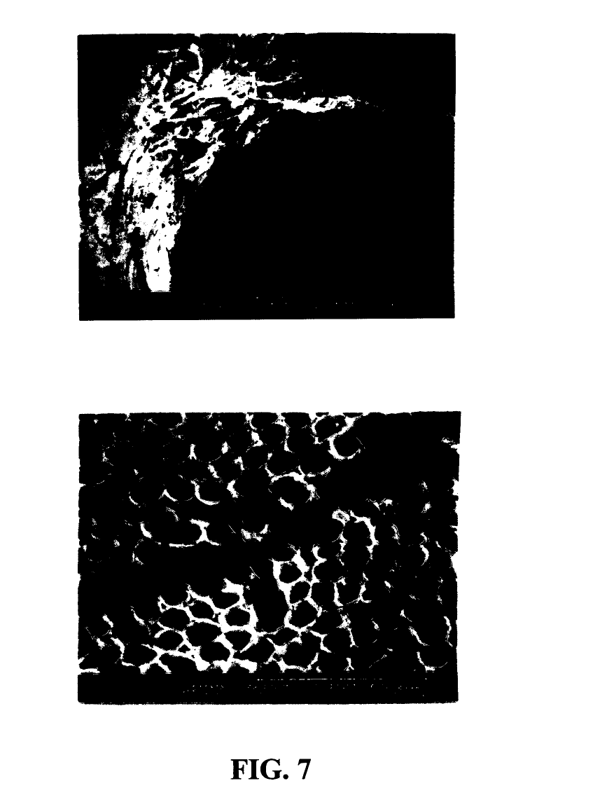

The composite fiber of the present invention can be prepared by coating the core fiber with an organic polymer via a reaction coating process, by placing the core fiber in a reaction solution that contains a monomer of the organic polymer and a chemical reagent capable of initiating or inducing monomer polymerization. When the coating material is a non-conjugated polymer, then the monomer is preferably selected from the group comprising of substituted or unsubstituted acrylonitriles, substituted or unsubstituted vinyl chlorides, substituted or unsubstituted vinyl alcohols, or substituted or unsubstituted vinyl acetates. When the coating material is a conjugated polymer, then the useful monomers for performing such reaction coating are substituted or unsubstituted anilines, substituted or unsubstituted pyrroles, substituted or unsubstituted thiophenes, substituted or unsubstituted furans, substituted or unsubstituted benzenes, substituted or unsubstituted thiophenols, substituted or unsubstituted acetylenes, or substituted or unsubstituted arylacetylenes, and other aromatics, or heteroaromatics. In the preferred embodiments of this invention, conjugated conducting polymer (homopolymer or copolymer) coating layers are prepared via the reaction coating from their corresponding monomers, as illustrated in the Formula from XXI to XXIV of FIG. 6;

wherein:

k is an integer from 0 to 4, or 5, or 6;

R₁ is the same or different at each occurrence and is selected from the group consisting of alkyl, deuterium, alkenyl, alkoxy, cycloalkyl, cycloalkenyl, alkanoyl, alkylthio, aryloxy, alkylthioalkyl, alkylaryl, arylalkyl, amino, alkylamino, dialkylamino, arylamino, diarylamino, alkylarylamino, aryl, alkylsulfinyl, aryloxyalkyl, alkylsulfinylalkyl, alkoxyalkyl, phosphonic acid, alkylsulfonyl, arylthio, alkylsulfonylalkyl, boric acid, phosphoric acid, sulfinate salts, arylsulfinyl, alkoxycarbonyl, arylsulfonyl, carboxylic acid, phosphonic acid, halo, hydroxy, cyano, sulfinic acid, carboxylate salts, borate salts, phosphate salts, sulfonate salts, phosphinate salts, phosphonate salts, phosphonic acid, sulfonic acid, nitro, alkylsilyl; or any of the foregoing aryl or aliphatic or cycloaliphatic groups substituted with one or more phosphonic acid, sulfonic acid, phosphoric acid, boric acid, carboxylate salt, borate salt, sulfonate salt, phosphinate salt, phosphonate salt, phosphate salt, phosphinic acid, carboxylic acid, halo, nitro, amino, alkylamino, dialkylamino, arylamino, diarylamino, alkylarylamino, cyano or epoxy moieties; or any two R₁ groups together, or any R₁ group together with any R₂ group may form a substituted or unsubstituted alkylene or alkenylene or alkynylene chain completing a 3, 4, 5, 6, 7, 8, 9 or 10 membered aromatic, heteroaromatic, heteroalicyclic or alicyclic ring, which ring may optionally include one or more divalent nitrogen, sulfur, sulfinyl, ester, carbonyl, sulfonyl, or oxygen atoms wherein permissible substituents are one or more phosphonic acid, sulfonic acid, phosphoric acid, boric acid, carboxylate salt, borate salt, sulfonate salt, phosphinate salts, phosphonate salt, phosphate salt, phosphinic acid, carboxylic acid, halo, nitro, amino, alkylamino, dialkylamino, arylamino, diarylamino, alkylarylamino, cyano, or epoxy moieties; or R₁ is an aliphatic moiety having repeat units of the formula:

—(OCH₂CH₂)_{q}OCH₃, —(OCH₂CH(CH₃))_{q}OCH₃,

—(CH₂)_{q}—CF₃, —(CF₂)_{q}—CF₃ or —(CH₂)_{q}—CH₃

wherein q is a positive whole number; and

R₂ is selected from the group consisting of permissible R₁ substituents and hydrogen.

X₁ and X₂ are the same or different and are S, O, Se, NR₄, PR₄, or CR₅R₆, wherein R₄, R₅, and R₆ are the same or different at each occurrence and are hydrogen, alkylaryl, arylalkyl, alkyl or R₁.

Illustrative of useful R₁ groups are hydrogen, alkyl, such as methyl, ethyl, octyl, nonyl, tert-butyl, neopentyl, isopropyl, sec-butyl, dodecyl and the like; alkenyl such as 1-propenyl, 1-butenyl, 1-pentenyl, 1-hexenyl, 1-heptenyl, 1-octenyl and the like; alkoxy such as propoxy, butoxy, methoxy, isopropoxy, pentoxy, nonoxy, ethyoxy, octoxy, and the like; cycloalkenyl such as cyclohexenyl, cyclopentenyl and the like; alkanoyl such as butanoyl, pentanoyl, octanoyl, ethanoyl, propanoyl and the like; amino; alkylamino, such as methylamino, ethylamino, butylamino and the like; dialkylamino, such as dimethylamino, methylethylamino and the like; arylamino such as phenylamino, p-methylphenylamino and the like; diarylamino, such as diphenylamino, p-nitrophenyl-p′-methylphenyl-amino and the like; alkylarylamino, such as 2-phenyl-4-methylamino and the like; alkylsulfinyl, alkylsulfonyl, alkylthio, arylthio, arylsulfinyl, and arylsulfonyl such as butylthio, neopentylthio, methylsulfinyl, benzylsulfinyl, phenylsulfinyl, propylthio, octylthio, nonylsulfonyl, octylsulfonyl, methylthio, isopropylthio, phenylsulfonyl, methylsulfonyl, nonylthio, phenylthio, ethylthio, benzylthio, phenethylthio, sec-butylthio, naphthylthio and the like; alkoxycarbonyl such as methoxycarbonyl, ethoxycarbonyl, butoxycarbonyl and the like; cycloalkyl such as cyclohexyl, cyclopentyl, cyclooctyl, cycloheptyl and the like; alkoxyalkyl such as methoxymethyl, ethoxymethyl, butoxymethyl, propoxyethyl, pentoxybutyl and the like; aryloxyalkyl and aryloxyaryl such as phenoxyphenyl, phenoxymethyl and the like; and various substituted alkyl and aryl groups such as 1-hydroxybutyl, 1-aminobutyl, 1-hydroxypropyl, 1-hydroxypentyl, 1-hydroxyoctyl, 1-hydroxyethyl, 2-nitroethyl, trifluoromethyl, 3,4-epoxybutyl, cyanomethyl, 3-chloropropyl, 4-nitrophenyl, 3-cyanophenyl, and the like; acid and acid salts such as sulfonic acid, carboxylic acid and salts thereof; aliphatic or aryl groups substituted with an acid or salt thereof such as phosphonic acid, phosphinic acid, sulfonate salt, sulfinate salt, sulfonic acid, sulfinic acid, borate salt, phosphoric acid, boric acid, or carboxylic acid groups such as ethylsulfonic acid, propylsulfonic acid, 4-nitrobenzene sulfonic acid, butylsulfonic acid, phenylsulfonic acid, and the like.

Also illustrative of useful R₁ groups are divalent moieties derived from any two R₁ groups, or a R₁ group with a R₂ group, or a R₁ group with a R₄ or a R₅ or a R₆ group such as moieties having from about 2 to about 7 repeat units in various combination and various occurrence order of the following formula:

—(C(R₃)₂)ₐ—

—(CR₃═CR₃)_{b}—

wherein R₃ is the same or different at each occurrence and is hydrogen, alkyl, alkoxy, or R₁, as for example —(CH₂)₄—, —(CH₂)₃—, —(CH═CH—CH═CH)—, —(CH₂—CH(CH₃)—CH₂)— and —(CH₂)₅—, and groups comprised of such moieties which include one or more heteroatoms of oxygen, nitrogen, ester, sulfonyl, carbonyl, sulfinyl, and/or sulfur, such as —CH₂SCH₂— —CH₂NHCH₂—, —SCH₂NHCH₂—, —O—CH₂—CH₂—O—CH₂—S—CH₂—, —CH₂S(O₂)CH₂—, —CH₂S(O)CH₂—, —OC(O)CH₂CH₂—, —CH₂C(O)CH₂— and —CH₂—O—CH₂— to form heterocyclic amino compounds such as tetrahydronaphthylamine, dihydrobenzopyrroleamine, benzofuranamine, dihydrobenzopyranamine, dihydrobenzofuranamine, dihydrobenzoparaoxazineamine, dihydrobenzoparadiazineamine, dihydrobenzotriazoleamine, dihydrobenzothiazineamine, benzothiopyranamine, dihydrobenzoxazoleamine and the like. Exemplary of useful R₃ groups are divalent alkenylene chains containing 1 to about 3 unsaturated bonds such as divalent 1,3-butadiene and like moieties which may also include one or more divalent oxygen, nitrogen, sulfinyl, sulfonyl, carbonyl, ester, and/or sulfur groups which form such compounds as benzodiazineamine, benzodiazoleamine, benzotriazepineamine, benzimidazolylamine, benzisoxazoleamine, benzoxazolylamine, benzothiazineamine, benzoxazineamine, naphthaleneamine, benzopyranamine, benzothiazineamine, anthraceneamine, aminobenzothiopyran, aminobenzodiazine, benzthiopyrone amine, aminocoumarin, benzothiopheneamine, benzothiodiazoleamine, and the like.

Exemplary of useful R₂ groups are hydrogen and the above-referenced representative R₁ groups described above such as alkyl as for example, methyl, ethyl, isopropyl, butyl, isobutyl, hexyl, octyl and the like; alkylsulfonyl such as methylsulfonyl, ethylsufonyl, propylsulfonyl and the like, arylsulfonyl such as phenylsulfonyl, p-methylphenylsulfonyl, naphthylsulfonyl and the like.

In the preferred embodiments of this invention, conjugated conducting polymer (homopolymer or copolymer) skin layers are prepared via the reaction coating from their corresponding monomers, as illustrated in the Formula from XXI to XXIV:

k is an integer from 0 to about 2;

R₁ is aryl, alkyl, alkylthio, arylthio, or alkoxy having from 1 to about 30 carbon atoms, cyano, halo, sulfonic acid, carboxylic acid, boric acid, borate salt, phosphoric acid, phosphate salt, phosphonic acid, phosphonate salt, phosphinic acid, phosphinate salt, sulfinic acid, sulfinate salt, carboxylate salt, sulfonate salt, amino, alkylamino, dialkylamino, arylamino, hydroxy, nitro, alkythio, arylthio, diarylamino, alkylarylamino; or alkyl, aryl, alkylthio, arylthio, or alkoxy substituted with phosphonic acid, phosphate salt, phosphoric acid, borate salt, sulfonate salt, amino, alkylamino, dialkylamino, arylamino, diarylamino, alkylarylamino, carboxylate salt, hydroxy, alkoxy, phosphonic acid, boric acid, alkyl, phosphinic acid, phosphonate salt, phosphinate salts, carboxylic acid or sulfonic acid substituents; and R₂ is the same or different at each occurrence and is a R₁ substituent or hydrogen.

X₁ and X₂ are the same or different and are S, O, NR₄, PR₄, or CR₅R₆, wherein R₄, R₅, and R₆are the same or different at each occurrence and are hydrogen, alkylaryl, arylalkyl, alkyl or R₁.

In the particularly preferred embodiments of this invention, conjugated conducting polymer (homopolymer or copolymer) skin layers are prepared via the reaction coating from their corresponding monomers, as illustrated in the Formula from XXI to XXIV of FIG. 6; wherein:

k is an integer from 0 to 1;

R₁ is aryl, alkyl, alkylthio, arylthio, or alkoxy having from 1 to about 20 carbon atoms, sulfonic acid, halo, carboxylic acid, amino, carboxylate salt, alkylamino, phosphonate salt, dialkylamino, arylamino, phosphonic acid, boric acid, phosphate salt, phosphoric acid, borate salt, diarylamino, alkylarylamino, or alkyl, alkylthio, arylthio, or aryl substituted with carboxylic acid, phosphoric acid, boric acid, phosphate salt, phosphonic acid, borate salt, sulfonate salt, amino, alkylamino, dialkylamino, arylamino, diarylamino, alkylarylamino, carboxylate salt, halo, phosphonate salt, or sulfonic acid substituents; and

R₂ is the same or different at each occurrence and is a R₁ subsituent or hydrogen.

X₁ and X₂ are the same or different and are S, O, NR₄, or CR₅R₆, wherein R₄, R₅, and R₆ are the same or different at each occurrence and are hydrogen, alkylaryl, arylalkyl, alkyl or R₁.

While the present invention has been particularly shown and described with reference to the preferred embodiments thereof, the embodiments are not intended to be exhaustive or to limit the present invention to the precise forms disclosed herein. It will be understood by those skilled in the art that various changes in form and detail may be made therein without departing from the spirit and scope of the invention. Similarly, any process steps described may be interchangeable with other steps in order to achieve the same result. The scope of the present invention is defined by the following claims and their equivalents.

What is claimed is:

1. A device, comprising:
an assembled structure of a plurality of carbonized carbon tubes, said assembled structure is prepared according to a process including the steps of:
coating a plurality of fibers with a carbonizable carbon-containing material to form a coating layer on each of said plurality of fibers;
assembling said plurality of coated fibers to form an assembled matrix;
binding said assembled matrix with one or more binding agents;
removing said plurality of fibers; and
carbonizing said coating layer and the residue of said fibers to form said assembled structure containing a plurality of carbonized carbon tubes.

2. The device according to claim 1, wherein said fibers are selected from the group consisting of monofilaments, yarns, woven cloths, non-woven fabrics, and combinations thereof.

3. The device according to claim 1, wherein the binding step utilizes a chemical material as the binding agent, selected from the group consisting of polymer, oligomer, resin, adhesive, sol gel, metal oxide, metal, ceramic, cement, epoxy resin, and combinations thereof.

4. The device according to claim 3, wherein the chemical material is thermally more stable than the coating material.

5. The device according to claim 3, wherein the chemical material is thermally less stable than the coating material.

6. The device according to claim 1, wherein said binding agent is a chemical reagent that is able to chemically or physically interact with the surfaces of said coating layers and result in interfacial bonding structures among said carbon tubes.

7. The device according to claim 1, wherein said binding agent is a chemical reagent that is able to physically wet or swell said coated fibers totally or in part and render said coated fibers sticking to or interpenetrating into each other at the contacted surfaces.

8. The device according to claim 1, wherein the binding step utilizes a crosslinking reagent as the binding agent, selected from the group consisting of peroxide, hydroperoxide, azo compound, redox initiator, photoinitiator, sulfur, and combinations thereof.

9. The device according to claim 1, wherein the binding step utilizes a binding agent that is carbonizable.

10. The device according to claim 1, wherein the binding step utilizes an energy beam as the binding agent, selected from the group consisting of lasers, ultraviolet light, visible light, high energy radiations, γ-ray, x-ray, electrons, high-speed particles, photons, and combinations thereof.

11. The device according to claim 1, wherein the binding step utilizes a reactive atmosphere as the binding agent, selected from the group consisting of plasma, hot air, ozone, and combinations thereof.

12. The device according to claim 1, wherein the binding step utilizes an energy flux as the binding agent, selected from the group consisting of microwave, infrared radiation, heat, and combinations thereof.

13. The device according to claim 1, wherein the binding step is further repeated utilizing the same or different types of binding agents.

14. The device according to claim 1, wherein the assembling step utilizes an assembling method selected from the group consisting of packing, weaving, knitting, netting, threading, sewing, stitching, stringing, wiring, tying, braiding, wrapping, binding, fastening, winding, stapling, and combinations thereof.

15. The device according to claim 1, wherein the removing step and carbonizing step are performed concurrently.

16. A device of an assembled structure, comprising:
a plurality of carbonized carbon tubes wherein said plurality of carbonized carbon tubes include:
carbonized coating material;
carbonized fiber residue; and
a binding element which binds the plurality of carbonized carbon tubes.

17. The device according to claim 16, wherein the binding element is a carbonized binding agent.

18. The device according to claim 16, wherein the binding element is interfacial covalent bonding structures at the contacted surfaces between said carbon tubes.

19. The device according to claim 16, wherein the binding element provides interfacial covalent bonds at the contacted surfaces between said carbon tubes.

20. The device according to claim 16, wherein the binding element provides inorganic network structures, which hold or bind said assembled structure of carbon tubes.

21. The device according to claim 16, wherein the binding element is a fused and interpenetrated interfacial structure of said carbonized coating material.

22. The device according to claim 16, wherein said assembled structure of carbon tubes is a rod or cylinder with the averaged axis of said carbon tubes being aligned along with the axis of said assembled structure.

23. The device according to claim 16, wherein said assembled structure of carbon tubes is a plate or mesh.

24. A method for making an assembled structure of carbon tubes, comprising the steps of:
coating a plurality of fibers with a coating material to form a coating layer over the fibers;
assembling said coated fibers into an assembled matrix;
binding said assembled matrix with one or more types of binding agents;
removing said fibers; and
carbonizing said coating layers and residue of said fibers to form said assembled structure of carbon tubes.

25. The method according to claim 24, wherein said fibers are selected from the group consisting of monofilaments, yarns, woven cloths, non-woven fabrics, and combinations thereof.

26. The method according to claim 24, wherein the binding step utilizes a chemical material as the binding agent, selected from the group consisting of polymer, oligomer, resin, adhesive, sol gel, metal oxide, metal, ceramic, cement, epoxy resin, and combinations thereof.

27. The method according to claim 26, wherein the chemical material is thermally more stable than the coating material.

28. The method according to claim 26, wherein the chemical material is thermally less stable than the coating material.

29. The method according to claim 24, wherein said binding agent is a chemical reagent that is able to chemically or physically interact with the surfaces of said coating layers and result in interfacial bonding structures among said carbon tubes.

30. The method according to claim 24, wherein said binding agent is a chemical reagent that is able to physically wet or swell said coated fibers totally or in part and render said coated fibers sticking to or interpenetrating into each other at the contacted surfaces.

31. The method according to claim 24, wherein the binding step utilizes a crosslinking reagent as the binding agent, selected from the group consisting of peroxide, hydroperoxide, azo compound, redox initiator, photoinitiator, sulfur, and combinations thereof.

32. The method according to claim 24, wherein said binding agent is carbonizable.

33. The method according to claim 24, wherein the binding step utilizes an energy beam as the binding agent, selected from the group consisting of lasers, ultraviolet light, visible light, high energy radiations, γ-ray, x-ray, electrons, high-speed particles, photons, and combinations thereof.

34. The method according to claim 24, wherein the binding step utilizes a reactive atmosphere as the binding agent, selected from the group consisting of plasma, hot air, ozone, and combinations thereof.

35. The method according to claim 24, wherein the binding step utilizes an energy flux as the binding agent, selected from the group consisting of microwave, infrared radiation, heat, and combinations thereof.

36. The method according to claim 24, wherein the binding step is further repeated utilizing the same or different types of binding agents.

37. The method according to claim 24, wherein the assembling step utilizes an assembling method selected from the group consisting of packing, weaving, knitting, netting, threading, sewing, stitching, stringing, wiring, tying, braiding, wrapping, binding, fastening, winding, stapling, and combinations thereof.

38. The method according to claim 24, wherein the removing step and carbonizing step are performed concurrently.
